(19) United States
(12) Patent Application Publication
(10) Pub. No.: US 2025/0326108 A1
(43) Pub. Date: Oct. 23, 2025

(54) EXOSKELETON AND METHOD FOR OPERATING IT

(71) Applicant: HAWE Hydraulik SE, Aschheim (DE)

(72) Inventor: Matthias Kube, Regensburg (DE)

(73) Assignee: HAWE Hydraulik SE, Aschheim (DE)

(21) Appl. No.: 18/869,974

(22) PCT Filed: May 30, 2023
(86) PCT No.: PCT/IB2023/020030

§ 371 Date: Nov. 27, 2024

(30) Foreign Application Priority Data
Jun. 2, 2022 (DE) 10 2022 114 023.7

(51) Int. Cl. B25J 9/00; A61H 1/02

(52) U.S. Cl. CPC B25J 9/0006; A61H 1/0244

(57) ABSTRACT

The invention discloses an exoskeleton (10) for a human person (8) for assisting and/or extending the range of motion and locomotion of the subject, and a method for operating and handling such an exoskeleton (10). The exoskeleton (10) is provided with a plurality of sections (12, 14, 16) and associated connecting joints (20, 24, 28) and can be operated in a walking mode and in a rolling mode. The lower leg sections (16) and/or the knee or second connecting joints (24) are associated with motor-driven wheels (32), which are inactive in a walking mode of the exoskeleton (10) when the person (8) is standing on the ground or moving by means of walking and/or stepping and/or climbing and/or running movements and are in a position at a distance from the ground and/or from the foot section (18) of the exoskeleton (10), and which are activated and/or motor-driven in a rolling mode of the exoskeleton (10) and are in contact with the ground.

The present invention relates to an exoskeleton for a human being to support and/or extend the range of movement and locomotion of the human being, as well as to a method for operating and handling such an exoskeleton,

Exoskeletons coupled with parts of a person's body are used for various purposes, for example to enable the person to carry out activities that they would not be able to carry out without the exoskeleton, or only to a limited extent, such as lifting heavy loads or other heavy physical activities. The use of exoskeletons tends to prevent overuse injuries to the human body that are triggered or caused by physical work and makes some activities possible in the first place, for which the physical strength and/or physical endurance would not be sufficient under normal circumstances.

If exoskeletons can generally be regarded as special types of machines for supporting the movement of people, this term also covers other devices, such as prostheses of all kinds, but also wheelchairs. If the prostheses work with motorized support, they can also be regarded as a special type of exoskeleton. Electrically powered wheelchairs also have many things in common with exoskeletons, such as the human-machine interface and the input devices required to transmit the movement requests of the person sitting in the wheelchair to the machine.

Although numerous designs of motor-assisted prostheses, exoskeletons and wheelchairs have become known, sometimes in different combinations of the features and capabilities typical of the respective category, there is a particular lack of concepts in practice to provide people with limited motor skills, for example due to paralysis, with a universally usable aid that can meet different movement and locomotion requirements in equal measure.

While the primary aim of wheelchairs is to provide physically impaired people with a certain degree of personal mobility, the motivation for using exoskeletons can go even further For example, an important main motivation for wearing and using exoskeletons is to enable physically impaired people to walk again, for example people with partial or complete paraplegia, stroke patients, elderly people or any other person whose ability to walk is at least limited.

It can therefore be regarded as a primary objective of the invention to extend the range of locomotion types and/or variants in an exoskeleton that supports human walking, without the need for costly conversion work or a time-consuming change of the machine that supports or enables locomotion.

This aim of the invention is achieved with subject matter of the independent claims. Features of preferable further embodiments of the invention can be found in the dependent claims.

Thus, in order to achieve the mentioned objective, the invention proposes an exoskeleton for a human person to support the person's movement and/or to extend the person's range of movement and locomotion with the features of independent claim 1. If, here and in the context of the following description, reference is only made in very general terms to movement support for a person wearing the exoskeleton according to the invention, it should be made clear at this point that this can also mean the recovery of a previously non-existent or lost ability to walk on the part of the person wearing the exoskeleton. For example, paralyzed persons who were previously able to regain a certain degree of personal mobility by using a wheelchair can now also be enabled to walk upright, climb stairs or overcome other obstacles by using an exoskeleton according to the invention

The exoskeleton according to the invention comprises at least one torso module supporting the torso of the person wearing the exoskeleton and anchored to the torso of the person, two thigh sections adjoining the torso module and each articulated thereto, lower leg sections adjoining the thigh sections and each articulated thereto, and foot sections adjoining the lower leg sections and each articulated thereto and each supporting and receiving a foot of the person concerned.

Furthermore, the exoskeleton is provided with first connecting joints with associated first drive motors for articulated connection and/or for motorized movement support between the torso module and the respective thigh sections when the exoskeleton is attached to the respective human person, approximately in the area of the hip joints of the human person.

In addition, second connecting joints with associated second drive motors for articulated connection and/or for motorized movement support between the respective thigh sections and the respective associated lower leg sections are located approximately in the area of the knee joints of the human or person when the exoskeleton is placed on the human or person and prepared for a walking mode.

Furthermore, third connecting joints for the articulated connection between the respective lower leg sections and the respective associated foot sections are located approximately in the area of the person's ankle joints when the exoskeleton is attached to the person.

Thus, the exoskeleton defined here is first of all such an exoskeleton which is connected to the torso and to both legs of the person and whose articulated sections are configured accordingly to enclose, support or guide the legs of the person and thus to be able to provide assistance or support to the legs within the scope of their conventional mobility or to enable at least some of the usual leg movements in the first place.

The lower leg sections and/or the knee joints are associated with motor-driven wheels which are inactive in a walking mode of the exoskeleton when the person is standing on the ground or moving by means of walking and/or stepping and/or climbing and/or running movements and are in a position at a distance from the ground and/or the foot section of the exoskeleton. The wheels are also activated and/or motor-driven in a rolling mode of the exoskeleton and are in contact with the ground.

The basic structure of the exoskeleton according to the invention is characterized by the fact that additional wheels are provided, each of which has a motor drive, but which is not used in the walking mode of the exoskeleton. Furthermore, the wheels are inactive in the walking mode of the exoskeleton and are not in rolling contact with the ground, so that they are largely functionless in an area between the ankles and the knee joints, optionally also directly at the knee joints. If the exoskeleton is to be converted to a rolling mode because the person equipped with the exoskeleton or wearing the exoskeleton wants to move faster than would be possible in walking mode, the wheels are in contact with the ground and the motorized drive is activated.

Optionally, in the exoskeleton according to the invention, the third connecting joints can also be assigned third drive motors for motorized movement support of the articulated connection between the respective lower leg sections and the respective associated foot sections. However, these third drive motors are not to be regarded as a mandatory feature, since instead of such third drive motors at the articulated connection between the respective lower leg sections and the respective associated foot sections, an alternative embodiment is also conceivable in which passive movement control in the corresponding foot joints of the exoskeleton is conceivable, which supports the usual walking movements in a similar way to a joint design in foot prostheses and behaves in a similar way to the human foot.

However, the invention is not limited to the three connecting joints described or to just three drive motors. It may well be that the exoskeleton comprises more than three connecting joints or more than three drive motors in order to increase the number of degrees of freedom for the lower extremities accordingly.

In a first embodiment of the exoskeleton according to the invention, the motor-drivable wheels are assigned to the knee joints and/or positioned in the vicinity of the knee joints. In this first variant, the wheels are each firmly anchored, namely directly in the region or in the vicinity of the knee joints, where the thigh sections and the lower leg sections are each connected to one another in an articulated manner.

The second connecting joints of the exoskeleton, together with the motor-drivable wheels assigned to them and/or positioned in their vicinity, are not connected to each other in this first variant, when the exoskeleton is in walking mode and the person is standing on the ground of moving by means of walking and/or stepping and/or climbing and/or running movements, the first drive motors are assigned to the knee joints of the wearer and follow the knee movements during the walking and/or stepping and/or climbing and/or running movements of the person and/or support the knee movements by means of the second drive motors in a motorized manner.

As will be explained in more detail below, the second drive motors associated with the second joints or knee joints can support the knee joints when the exoskeleton is in walking mode, while they can also serve as drive motors for the drive wheels when the exoskeleton is in rolling mode.

In addition to the walking mode, the exoskeleton also has the aforementioned rolling mode, which in the first embodiment of the exoskeleton described here is characterized by the fact that the second connecting joints, together with the motor-driven wheels assigned to them and/or positioned in their vicinity, are distanced from the knee joints of the person. Furthermore, the wheels associated with the second joints are in contact with the ground in this rolling mode of the exoskeleton and are each motor-driven. In addition, the person connected to the exoskeleton is in a seated position in the rolling mode.

The rolling mode ensures that the thigh sections are aligned approximately vertically and that the lower leg sections, which are articulated to them, are aligned approximately horizontally Starting from the torso module, the thigh sections continue to point downwards in a vertical direction, but are no longer parallel to the thighs of the person wearing the exoskeleton and therefore no longer run along the outer sides of the thighs, as the person is in a seated position with the thighs aligned approximately horizontally.

At the end of the vertically aligned thigh sections are the driven wheels and the second connecting joints, which establish the articulated connection to the lower leg sections. In the rolling mode of the exoskeleton, these lower leg sections are aligned approximately horizontally and close to the ground and continue to be articulated to the third connecting joints, as the person's feet normally continue to stand on the foot sections or are associated with the foot sections of the exoskeleton in rolling mode.

Furthermore, in the first embodiment of the exoskeleton, the lower leg sections are preferably equipped with, in particular, non-driven support rollers which are in contact with the ground when the lower leg sections of the exoskeleton in rolling mode are aligned approximately horizontally, the foot sections being at least slightly raised from the ground. The support rollers are sensibly located in an area of the lower leg sections which is in each case closer to the third connecting joints than to the second connecting joints, since a sufficient distance from the driven wheels, which are located at the second connecting joint, is necessary for the stabilizing effect of the support rollers.

Optionally, the support rollers can have a steering mechanism to make the exoskeleton, which also functions as a wheelchair, steerable in rolling mode. However, in the case of support rollers mounted loosely and rotatable about vertical axes, steering can also be achieved by variably driven drive wheels, which can initiate steering impulses by means of different drive and/or deceleration powers.

Preferably, in the first embodiment of the exoskeleton, the torso module can be assigned an adjustable seat surface for the human person in a seated position, so that the person using the exoskeleton in the rolling mode sits, as it were, in a wheelchair formed by the exoskeleton brought into the rolling mode and can be moved by it in a rolling manner of can move about with its help in a rolling manner.

The first embodiment of the exoskeleton can thus be characterized by the fact that the person coupled to it can change from a standing to a sitting posture and vice versa. In the seated posture of the person required for the rolling mode, the thigh sections and the lower leg sections each detach from the upper and lower legs of the person, while a seat surface arranged on the torso module is activated, so that not only is the posture of the person a seated posture, but the person actually rests seated on a correspondingly positioned seat surface. While in the walking position neither the drivable wheels nor the optional but preferably available support rollers are in contact with the ground but have no function, in the rolling mode they have rolling contact with the ground. Whether the thighs and lower legs of the person equipped and coupled with the exoskeleton are or should be connected to the lower leg sections or to the upper leg sections of the exoskeleton depends on the special configuration of the exoskeleton and, if necessary, on additional measures to stabilize the lower extremities in the walking mode of the exoskeleton and, if necessary, to prevent uncontrolled yielding or buckling. However, the close and stable connection between the torso module and the torso of the person wearing the exoskeleton normally prevents the legs from giving way or buckling.

In a second embodiment of the exoskeleton according to the invention, which differs structurally in some aspects from the first embodiment, the motor-drivable wheels are assigned to the lower leg sections and can also be adjusted along their longitudinal direction, by which is meant vertical adjustability along the longitudinal direction of the lower leg sections of the exoskeleton when the person is standing upright.

In this second embodiment of the exoskeleton according to the invention, the motor-driven wheels associated with the lower leg sections are inactive in the walking mode of the exoskeleton and are also in a raised position between the foot section and the knee joint at a distance from the floor and/or the foot section of the exoskeleton. The wheels are therefore non-functional when the exoskeleton is in walking mode. The upper end position of the motor-driven wheels, which are normally located on the outside of the lower leg of the person or the exoskeleton, can be located approximately in the middle of the lower leg sections, for example.

In the rolling mode of the exoskeleton, however, the motor-driven wheels are activated and are in contact with the ground, whereby the wheels in their lowered position lift the foot section off the ground so that only the wheels are in contact with the ground. The lower end position of the motor-driven wheels can preferably be approximately at the level of the person's ankles or at the level of the third connecting joints. This lower end position can mean in particular the area of the suspension or the drive axle of the wheels, because the wheels, which can have a diameter of approximately 15 to 30 cm, are in this case reliably in contact with the ground due to their size, while the lower support plates for the feet, which are generally referred to here as foot sections, have a sufficient distance from the ground of a few centimeters.

Since the second embodiment of the exoskeleton could not ensure the upright posture of the human wearer of the exoskeleton without additional support wheels, in this second embodiment the motor-driven wheels can be coupled to an electronic control device, at least in the rolling mode of the exoskeleton, which can provide balance control for a stabilized upright posture of the exoskeleton and the human supported and/or supported thereby.

Optionally, however, additional support rollers can be provided so that a total of four wheels or rollers are in contact with the ground in roll mode and can ensure stabilization of the exoskeleton together with the person carrying it.

In the rolling mode of the exoskeleton, no strong bending in the hip and/or knee joint is intended, but an essentially upright posture is aimed for and stabilized, so that preferably a permissible articulation angle of the second connecting joints in the rolling mode of the exoskeleton is minimized when the driven wheels are activated and in rolling contact with the ground and can reasonably be only a few degrees of angle.

In addition, a permissible articulation angle of the first connecting joints can also be minimized in the rolling mode of the exoskeleton when the driven wheels are activated and in rolling contact with the ground.

For both embodiments described here, it should also be pointed out that electric geared motors or other drive motors can be arranged in the first connecting joints, in the second connecting joints and possibly in the third connecting joints, which can provide motor support for the desired extensions of flexions around the knee joint and around the hip joint or can provide the corresponding extensions of flexions around the knee joint and around the hip joint in the first place.

At least with regard to the second embodiment variant, stabilization of the entire movement sequences can be supported as required by the use of additional arm crutches, for example if stairs are to be climbed. However, the use of arm crutches can also usefully support and/or facilitate normal walking movements.

It should be clarified that the terms walking, stepping, climbing and/or running used here are intended to cover all conceivable types of locomotion in which the person equipped with the exoskeleton either stands on both legs in walking mode or performs a type of walking or locomotion that corresponds in the broadest sense to human walking Climbing up or down stairs, ladders, ramps, etc. is also included in this definition, as the person adopts an upright posture.

To achieve the above objective, the invention further proposes a method for operating and handling an exoskeleton according to one of the embodiments described above, in which method the motor-drivable wheels associated with the lower leg portions and/or the knee joints are inactive in a walking mode of the exoskeleton when the human being is standing on the ground or moving by means of walking and/or stepping and/or climbing and/or running movements and are brought into a position distanced from the ground and/or from the foot section of the exoskeleton, the wheels being brought into contact with the ground in a rolling mode of the exoskeleton and being activated and/or motor. driven in the process.

The method may provide that the second connecting joints of the exoskeleton, together with the wheels assigned to them and/or positioned in their vicinity, are assigned to the knee joints of the wearer in the walking mode of the exoskeleton when the human being is standing on the ground or moving by means of walking and/or stepping and/or climbing and/or running movements and follow the knee movements during the walking and/or stepping and/or climbing and/or running movements of the human being and/or provide motor support for the knee movements by means of the second drive motors.

Furthermore, the method may provide that the second connecting joints, together with the motor-drivable wheels associated with them and/or positioned in their vicinity, are spaced apart from the knee joints of the human in the rolling mode of the exoskeleton, wherein the wheels associated with the second joints are in contact with the ground and are motor-driven, and wherein the human connected to the exoskeleton is in a seated position.

An alternative method variant, which relates to the second embodiment of the exoskeleton according to the invention, can provide that the motor-drivable wheels associated with the lower leg sections are inactive in the walking mode of the exoskeleton and are in a raised position between the foot section and the knee joint at a distance from the ground and/or from the foot section of the exoskeleton.

In addition, this method variant may provide for the motor-driven wheels to be activated in the exoskeleton's rolling mode and to be in contact with the ground, with the wheels lifting the foot section off the ground in their respective lowered position.

In addition, this method variant may provide for the motor-driven wheels to be coupled to a control and/or regulating device, at least in the rolling mode of the exoskeleton, which can provide balance control when the exoskeleton and the person supported and/or assisted by it are in a stabilized upright position. In addition, this optional control and/or regulating device can support the stability of the exoskeleton during any type of rolling locomotion and prevent it from falling over.

It should be expressly mentioned at this point that all aspects and embodiments explained in connection with the exoskeleton according to the invention equally relate to or can form partial aspects of the method according to the invention for its operation and handling. Therefore, if at any point in the description or also in the claim definitions of the exoskeleton according to the invention reference is made to certain aspects and/or relationships and/or effects, this applies equally to the method according to the invention. The same applies vice versa, so that all aspects and embodiment variants that were explained in connection with the method according to the invention for operating and handling the exoskeleton also relate to or can be partial aspects of the exoskeleton according to the invention. Therefore, if at any point in the description or also in the claim definitions of the method according to the invention reference is made to certain aspects and/or relationships and/or effects, this applies equally to the exoskeleton according to the invention.

In the following, exemplary embodiments will explain the invention and its advantages in more detail with reference to the attached figures. The proportions of the individual elements to one another in the figures do not always correspond to the actual proportions, since some shapes are simplified and other shapes are shown enlarged in relation to other elements for better illustration.

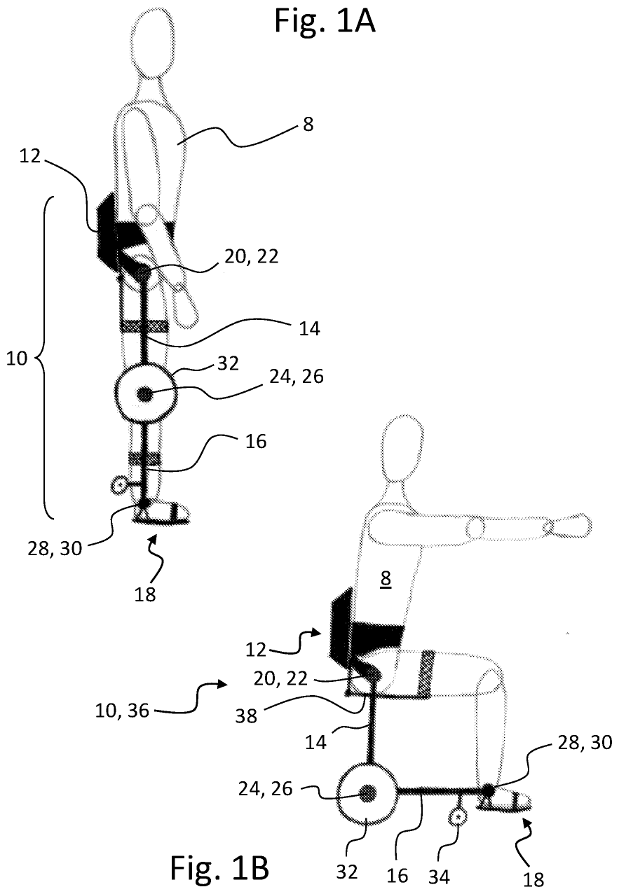

FIG. 1A shows a schematic side view of a person with a first embodiment of an exoskeleton according to the invention, which is in a walking mode.

FIG. 1B shows a schematic side view of the first embodiment of the exoskeleton converted to a rolling mode.

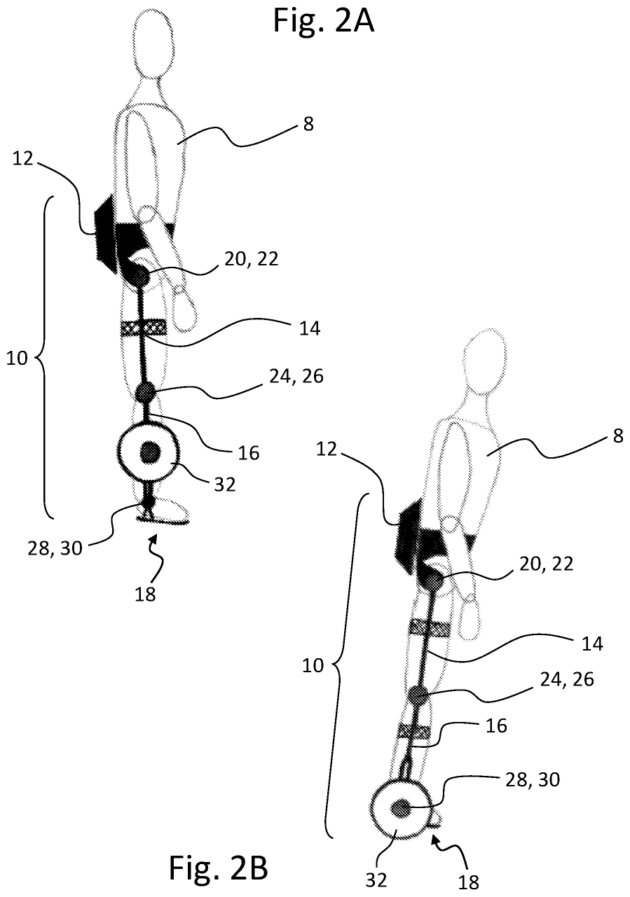

FIG. 2A shows a schematic side view of a person with a second embodiment of the exoskeleton according to the invention, which is in a walking mode.

FIG. 2B shows a schematic side view of the second embodiment of the exoskeleton converted into a rolling mode.

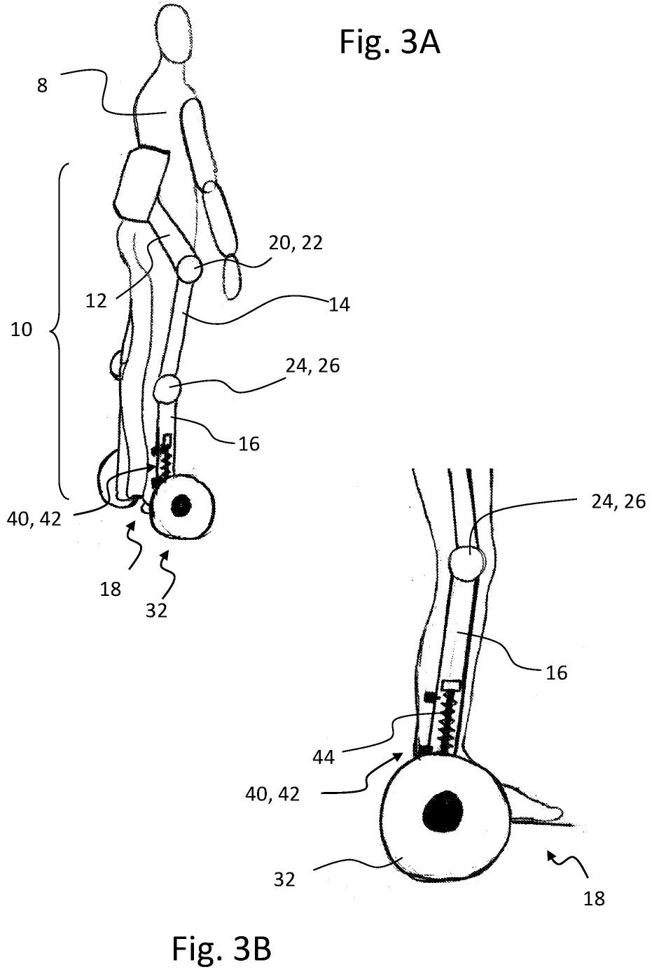

FIG. 3A shows a perspective view of a person equipped with an exoskeleton according to the second embodiment, wherein the exoskeleton is in rolling mode.

FIG. 3B shows a detailed perspective view of the lower section of the exoskeleton with motor-driven wheels that are in contact with the ground.

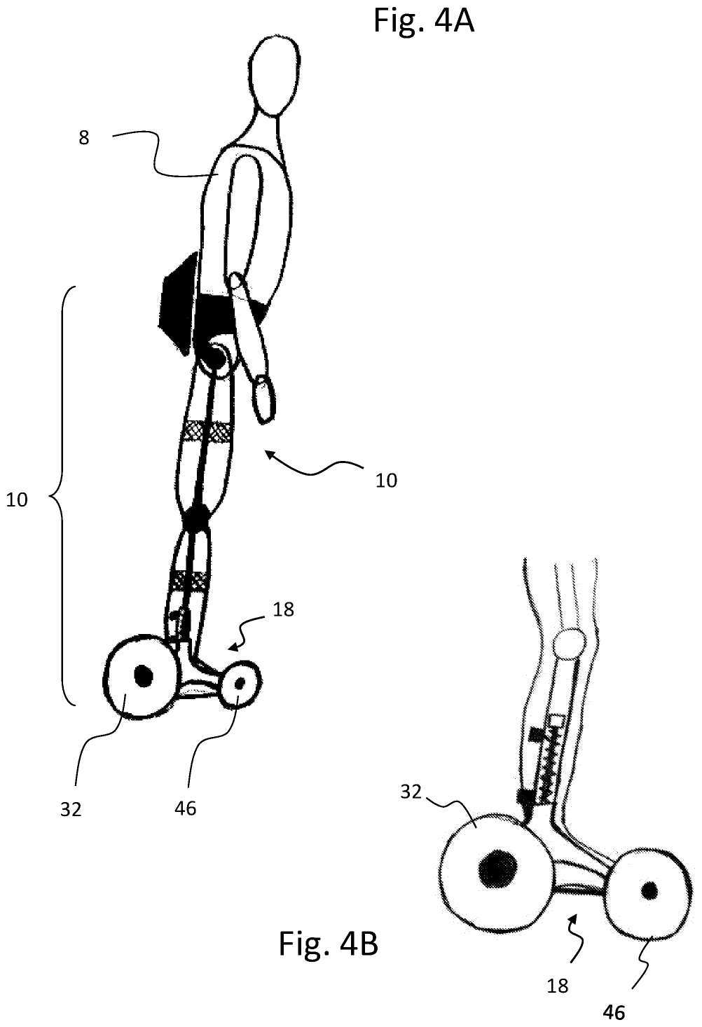

FIG. 4A shows a perspective view of a person equipped with an exoskeleton according to a third embodiment, wherein the exoskeleton equipped with additional support rollers is in rolling mode.

FIG. 4B shows a detailed perspective view of the lower section of the exoskeleton according to FIG. 4A with motor-driven wheels and non-driven support rollers, each of which is in contact with the ground.

Identical reference signs are used for elements of the invention that have the same or the same effect. Furthermore, for the sake of clarity, only reference signs which are necessary for the description of the respective figure are shown in the individual figures. The embodiments shown are merely examples of how the invention may be provided and do not represent an exhaustive limitation. The features described below are also not to be understood in close connection with further features of the respective embodiment example, but can be provided in a general context or be used for this purpose.

The schematic side views of FIGS. 1A and 1B illustrate a human person 8 with a first embodiment of an exoskeleton 10 according to the invention, which is in a walking mode in the representation of FIG. 1A, while FIG. 1B shows the exoskeleton 10 converted to a rolling mode.

As already explained above, the exoskeleton 10 shown can be used in particular to support the movement of the person 8 or to extend the range of movement and locomotion of the person 8 or also to enable a person 8 who is unable to walk to move more or less normally on their two legs. The exoskeleton 10 comprises a torso module 12, which is anchored to the torso of the person 8 and supports the torso, and two thigh sections 14, which adjoin the torso module 12 on the underside and are each connected to it in an articulated manner, an upper end of which is connected to the torso module 12 in an articulated manner and a lower end of which is connected to lower leg sections 16 in an articulated manner. These lower leg sections 16 are each adjoined by foot sections 18 which are hingedly connected thereto and which each support and accommodate the feet of the person 8.

In particular, plate-like foot supports can be provided to rest the soles of the person's feet on the foot sections 18.

What FIGS. 1A and 1B do not show, due to their schematic representation, are first connecting joints 20 with associated first drive motors 22 for articulated connection and for motorized movement support between the torso module 12 and the respective thigh sections 14, which are located in the exoskeleton 10 worn by the person 8 approximately in the area of his hip joints. The two first drive motors 22 can, for example, each be integrated in the first connecting joints 20 and in particular be formed by electric geared motors or other drive motors suitable for this purpose. In addition, it is useful to limit the mobility of the first connecting joints 20 at least to such an extent and to adapt it to a sensible body mobility of the person 8 that their hip joints or their other musculoskeletal system is not overloaded in any way or strained in an unreasonable manner.

Furthermore, second connecting joints 24 with associated second drive motors 26 are located between the respective thigh sections 14 and the respective associated lower leg sections 16 for articulated connection and for motorized movement support of knee flexion and extension, the second connecting joints 24 being located approximately in the region of the knee joints of the person. Again, the two second drive motors 26 can be integrated in the second connecting joints 24 and, in particular, can be formed by electric geared motors. In addition, it is useful to limit the mobility of the second connecting joints 24 at least to such an extent and to adapt it to a reasonable knee mobility of the person 8 that their knee joints are not overloaded or overstressed in any way.

Finally, third connecting joints 28 for the articulated connection between the respective lower leg portions 16 and the respective associated foot sections 18 are located approximately in the region or at the level of the ankle joints of the person 8. Optionally, third drive motors 30 or electric gear motors for motorized movement support of the articulated connection between the respective lower leg portions 16 and the respective associated foot sections 18 may also be associated with the third connecting joints 28. If such third drive motors 30 are dispensed with, passive movement control and/or movement influencing in the corresponding foot joints or third connecting joints 28 of the exoskeleton 10 is conceivable, which supports the usual walking movements in a similar way to a joint design in foot prostheses and behaves in a similar way to the human foot. Suitable passive elements include, for example, appropriately adapted spring elements, spring mechanisms, possibly with integrated dampers, etc. In principle, walking movements can be made possible in such a passive supportive manner without the foot sections 18 necessarily having to be equipped with third drive motors 30.

As illustrated by the schematic side view of FIG. 1A, the second connecting joints 24 are spatially associated with the knee joints of the exoskeleton 10 in the walking mode shown here when the person 8 is standing on the ground or moving by means of walking, stepping, climbing and/or running movements and follow the knee movements during the walking, stepping, climbing and/or running movements of the person 8 and/or support the knee movements by means of the second drive motors 26 in a motorized manner.

The schematic side view of FIG. 1B illustrates the rolling mode of the exoskeleton 10, in which the second connecting joints 24 are distanced from the knee joints of the person 8. The body connection of the exoskeleton 10 indicated schematically in of FIG. 1A is released here at least in the area of the thighs, in the area of the lower legs and possibly at the knees of the person 8 wearing the exoskeleton 10, for example by manually opening corresponding connections or stabilizations (not shown in detail here). It may be that the body connection comprises a bandage or the like, possibly comprising foam or other flexible or elastic materials, via which a person 8 is connected to the exoskeleton 10 in walking mode as shown in FIG. 1A. A connection via the body connection through the bandage can be removed, whereupon the exoskeleton 10 changes from the walking mode (FIG. 1A) to the rolling mode (FIG. 1B). The bandage can remain attached to the body of the person 8 so that a connection to the exoskeleton 10 can be re-established quickly and easily via the bandage when the exoskeleton 10 switches back from the rolling mode according to FIG. 1B to the walking mode according to FIG. 1A.

The rolling mode initially provides that the upper leg sections 14 continue to be aligned approximately vertically, i.e. as in the walking mode (FIG. 1A), while the lower leg sections 16 articulated thereto are now folded forward by approximately 90° in the second connecting joint 24 and are thus aligned horizontally. Starting from the torso module 12, the thigh sections 14 continue to point downwards in a vertical direction, but are no longer parallel to the thighs of the person 8 wearing the exoskeleton 10 and thus no longer run along the outer sides of the thighs, since the person 8 is in a seated position with the thighs aligned approximately horizontally. The second connecting joints 24 assume an angle of approximately 90° in a forward direction, which the knee joints of the person 8 cannot follow, since in humans a lock prevents the knee joints from being more than only slightly hyperextended beyond the extended position.

In order to make this rolling mode of the exoskeleton 10 effective, driven wheels 32 are arranged at the lower end of the vertically aligned thigh sections 14, which wheels 32 may in particular be associated with the second connecting joints 24 and, moreover, may usefully be driven by means of the second drive motors 26 of the second connecting joints 24. The motor-drivable or driven wheels 32 are inactive in the walking mode of the exoskeleton 10 when the person 8 is standing on the ground or moving by means of walking, striding, climbing and/or running movements and are in a position distanced from the ground and/or from the foot area 18 of the exoskeleton 10 (see FIG. 1A). In contrast, the driven wheels 32 are activated and motor-driven in the rolling mode of the exoskeleton 10 and are in contact with the ground (see FIG. 1B)

In the first embodiment of the exoskeleton 10 shown in FIGS. 1A and 1B, the motor-drivable wheels 32 can be associated with the knee joints or the second connecting joints 24 and/or positioned in the vicinity of these joints 24. In this first variant, the wheels 32 are preferably firmly anchored there in each case, so that the rolling mode can be activated by the folding movement of the exoskeleton 10 in the second connecting joints 24 while distancing the thigh sections 14 and the lower leg sections 16 (and when the body connection of the thigh sections 14 and the lower leg sections 16 is released or the body connection between the exoskeleton 10 and the thigh sections 14 and the lower leg sections 16 is released) of the exoskeleton 10 is established from the legs of the person 8, while the feet of the person 8 continue to stand on the foot sections 18 or remain associated with the foot sections 18 of the exoskeleton 10 in both the walking mode and the rolling mode.

Furthermore, in the first embodiment of the exoskeleton 10, the lower leg portions 16 are preferably provided with non-driven support rollers 34 which are in contact with the ground when the lower leg portions 16 of the exoskeleton 10 in the rolling mode (see FIG. 1B) are in an approximately horizontal orientation, the foot sections 18 with the feet of the person 8 resting thereon being at least slightly raised from the ground. The support rollers 34 are sensibly located in regions of the lower leg sections 16 that are relatively close to the third connecting joints 28 and the foot sections 18, so that there is sufficient distance from the driven wheels 32 for the stabilizing effect of the support rollers 34 in rolling mode. In walking mode, the support rollers 34 are inactive and project backwards from the lower leg sections 16 (see FIG. 1A).

Optionally, the support rollers 34 can have a suitable steering mechanism to make the exoskeleton 10, which also functions as a wheelchair 36, easier to steer in rolling mode. However, in the case of support rollers 34 mounted so as to rotate loosely about vertical axes, the steerability can also be achieved by variably driven drive wheels 32, which can introduce steering impulses into the wheelchair 36 by means of different drive and/or deceleration powers and thus make it steerable.

As can also be seen in FIG. 1B, the torso module 12 has an adjustable seat 38 for the person 8 sitting in the wheelchair 36. The seat surface 38 can be brought under the buttocks of the person 8 in the manner shown as soon as the exoskeleton 10 is converted to the rolling mode and functions as a wheelchair 36.

The schematic side views of FIGS. 2A and 2B show a second embodiment of the exoskeleton 10 according to the invention with a person 8 carrying the exoskeleton 10 or equipped with the exoskeleton 10, wherein FIG. 2A shows the exoskeleton 10 in a walking mode, while FIG. 2B shows the second embodiment of the exoskeleton 10 which is in a rolling mode.

The second embodiment of the exoskeleton 10 shown in FIGS. 2A and 2B, but also in the further views of FIGS. 3A, 3B, 4A and 4B, differs structurally in some aspects from the first embodiment, which will be described below in the most important details. The main difference is that the motor-drivable wheels 32 are associated with the lower leg sections 16, whereby they can be adjusted along the longitudinal direction of extension of the lower leg sections 16, by which is meant vertical adjustability along the longitudinal direction of the lower leg sections 16 of the exoskeleton 10 when the person 8 is standing upright.

As shown in FIG. 2A, the motor-drivable wheels 32 associated with the lower leg portions 16 are inactive in the walking mode of the exoskeleton 10 and are in a raised position distanced from the ground and/or the foot section 18 of the exoskeleton 10 between the foot section 18 and the second connecting joints 24 or the knee joints of the person 8. The wheels 32 are thus inoperative in the walking mode of the exoskeleton 10. The upper end position of the motor-driven wheels 32, which are normally located on the outside of the lower legs of the person 8 or on the outside of the lower leg sections 16 of the exoskeleton 10, can be located, for example, approximately in the middle of the lower leg sections.

It should be noted at this point that the other identical or similar elements of the second embodiment variant of the exoskeleton 10, which are marked with the same reference numerals as in FIGS. 1A and 1B, will not be explained again here, but only if they differ significantly from the first variant in the second embodiment variant explained in FIG. 2A ﬀ.

As can be seen in FIG. 2B, the motor-driven wheels 32 are activated in the rolling mode of the exoskeleton 10 and are each in contact with the ground, with the wheels 32 in their respective lowered positions lifting the foot section 18 off the ground so that only the wheels 32 are still in contact with the ground. The lower end position of the motor-driven wheels 32 assumed in this case can preferably be approximately at the level of the ankles of the person 8 or at the level of the third connecting joints 28 of the exoskeleton 10. This lower end position may in particular refer to the area of the suspension or the drive axle of the wheels 32.

The wheel axles are sensibly located approximately in areas which lie in the center of gravity of the body of the person 8 or which are at least close to this center of gravity.

The wheels 32 may have a diameter in a reasonable range of approximately 15 . . . 30 cm, so that they are reliably in contact with the ground in rolling mode due to their size, while the lower support plates for the feet, which are generally referred to here as foot sections 18, have a sufficient distance from the ground of a few centimeters.

Since the exoskeleton 10 could not ensure the upright posture of the human wearer of the exoskeleton 10 without additional support wheels (see FIGS. 1A and 1B), in this second embodiment the motor-driven wheels 32 can preferably be coupled to an electronic control and/or regulating device, at least in the rolling mode of the exoskeleton 10, which can provide balance control in a stabilized upright posture of the exoskeleton 10 and the person 8 supported of assisted thereby. When reference is made at this point to a stabilized upright posture of the exoskeleton 10, this does not only mean a rest mode in which the person 8 stands still with the aid of the exoskeleton 10, even if the wheels 32 touch the ground and the foot sections 18 are raised from the ground. The upright posture can be maintained with the aid of the electronic control and/or regulating device equally in driving mode with driven wheels 32 and the exoskeleton 10 rolling.

This electronic stabilization device is not shown in detail here, as it is part of the drive control of the entire exoskeleton 10 and its drive wheels 32 in rolling mode.

In the rolling mode of the exoskeleton 10, no pronounced bending in the hip and/or knee joint is sensibly permitted by its motion control, but an essentially upright posture is aimed for and stabilized, so that preferably a permitted articulation angle of the second connecting joints 24 in the rolling mode of the exoskeleton 10 is minimized when the driven wheels 32 are activated and in rolling ground contact and can sensibly be only a few degrees of angle. In addition, a permitted articulation angle of the first connecting joints 20 may also be minimized in the rolling mode of the exoskeleton 10 when the driven wheels 32 are activated and in rolling ground contact.

The exoskeleton 10 according to the second embodiment shown in FIGS. 2A and 2B thus remains in the upright orientation, while a transfer to the rolling mode by simulating a wheelchair 36 (cf. FIG. 1B) is not provided.

FIGS. 3A and 3B indicate an option for quickly transferring the wheels 32 from walking mode (FIG. 2A) to rolling mode (FIG. 2B) and vice versa. For example, the wheel suspensions 40 can each be suspended on linear guides 42, which allow linear movement of the wheel suspensions 40 along the longitudinal direction of extension of the respective lower leg sections 16 between the two end positions. Such linear guides 42 are to be understood merely as an exemplary possibility for permitting mobility of the wheel suspensions 40 between the two different end positions already described. For example, it is also conceivable that eccentrically acting mechanisms or other mechanisms are provided or suitable for ensuring mobility for the wheel suspensions 40 between different end positions.

In a first variant of the exoskeleton 10, the wheels 32 or their wheel suspensions can be locked in both end positions by means of the linear guide 42, which can be automated, semi-automated by corresponding manual actuation by the user. Thus, if the user or person 8 wants to switch from walking mode to rolling mode, he/she can release the lock and then lift one leg by bending it at the knee joint and possibly also at the hip joint and lift the foot section 18 off the ground while the other foot remains on the ground This type of movement may be facilitated by the use of crutches.

The wheel suspension 40 suspended on the linear guide 42 allows it or the wheel 32 arranged on it to fall downwards due to gravity when the foot is raised. It can then be locked in this lower position. The other foot can then be lifted in the same way after unlocking the wheel suspension 40, so that the wheel suspension 40 also drops the wheel 32 downwards.

Preferably, this phase of switching to roll mode in particular can be stabilized by using supporting arm crutches.

Conversely, in order to change from rolling mode to walking mode, locks of the linear guides 42 for the wheel suspensions 40 can be released, causing the person 8 to fall downwards together with the exoskeleton 10 until the foot sections 18 have reached the ground. In this case, the compression springs 44 on the outside of the lower leg sections 16 can ensure that the impact caused by this is weakened, as the compression springs 44 counteract the weight of the person 8 and can therefore reduce and dampen the impact shock when reaching the ground.

The linear guides 42 can then be locked again, thereby restoring the walking mode. It is immediately obvious that the wheels 32 cannot reach the height at the lower leg sections 16 as indicated in the schematic representation of FIG. 2A in this variant according to FIGS. 3A and 3B. Without further motorized support, the wheels 32 remain approximately at a height in walking mode at which they can at most be just above the foot sections 18. Alternatively, however, a motorized support in the linear guides 42 can ensure that the wheels 32 are raised and distanced from the ground. In such embodiments, it is not absolutely necessary for the wheels 32 to be spaced from the ground in walking mode. Thus, it is also quite possible that both the wheels 32 and the foot sections 18 are in contact with the ground in walking mode. If this is the case, it may be provided that the wheels 32, which are in contact with the ground in walking mode, are fixed or even locked in their respective rotational position.

In an alternative variant, which also refers to FIGS. 3A and 3B, the compression spring 44, which supports the respective linear guide 42 in a suitable manner and pretensions it in one direction, can optionally also ensure that the wheels 32 can reach the lower end position by releasing a corresponding locking mechanism under the effect of the restoring forces of the relaxing compression spring 44 and can establish the rolling mode of the exoskeleton 10 by lifting the foot sections 18 from the ground.

A motor-drivable drive within the linear guide 42 can pull the respective drive wheel 32 upwards towards the upper end position to establish the walking mode, so that the foot sections 18 come to rest on the floor again. Such a mechanism has the advantage that the motor-drivable drive of the linear guide 42 can be designed to be relatively weak, since the resetting and restoration of the preload of the compression spring 44 (see FIG. 3B), which is configured as a spiral spring, for example, is supported by the weight of the person 8 connected to the exoskeleton 10. In contrast, the main part of the actuating force required for lowering the wheels 32 is applied by the compression springs 44 when the exoskeleton 10 is raised from the ground, so that no further motorized actuating force or only a small additional proportion of motorized actuating force may have to be applied by the linear guide 42 in order to establish the rolling mode.

The wheel suspensions 40 can preferably be locked in the lower end position in the rolling mode so that no instabilities occur during rolling that could be introduced into the rolling exoskeleton 10 due to a deflection of the linear guides 42 as a result of the compliant compression springs 44, in particular when driving over uneven ground. Alternatively, however, such a spring effect may well be desirable and permitted by the design, although in this case a damping effect impressed on the linear guide 42 may be desirable.

FIGS. 4A and 4B illustrate a modification of the second embodiment of the exoskeleton 10, in which additional smaller support rollers can be provided below the foot sections 18, so that in rolling mode a total of four wheels 32 or rollers 46 are in contact with the ground and can provide stabilization of the exoskeleton 10 together with the person 8 carrying it

In this variant, the driven wheels 32 are pivoted to the rear in such a way that they are located behind the heel region of the foot sections 18 and

together with the support rollers 46 arranged below the foot sections 18 can ensure a sufficiently stable position of the exoskeleton 10 as it moves on wheels.

The invention has been described with reference to a preferred embodiment. However, it is conceivable to a person skilled in the art that modifications or changes to the invention can be made without departing from the scope of protection of the following claims.

### LIST OF REFERENCE SIGNS

8 person, human person
10 exoskeleton
12 torso module
14 thigh section
16 lower leg section
18 foot section
20 first connecting joint
22 first drive motor
24 second connecting joint
26 second drive motor
28 third connecting joint
30 third drive motor
32 wheel, drive wheel, driven wheel
34 support roller
36 wheelchair
38 seat surface
40 wheel suspension
42 linear guide
44 compression spring
46 support rollers

1.-20. (canceled)

21. An exoskeleton for a person for assisting a movement and/or extending a range of movement and locomotion of the person, the exoskeleton comprising:
a torso module supporting a torso of the person and anchored to the torso;
two thigh sections connected to the torso module and articulated thereto;
two lower leg sections adjoining the two thigh sections, wherein each lower leg section is connected to a respective one of the two thigh sections in an articulated manner; and
foot sections each adjoining the lower leg sections, each foot section of the foot sections connected to a respective one of the two lower leg sections in an articulated manner and each foot section supporting and receiving a foot of the person,
wherein first connecting joints with associated first drive motors for articulated connection and/or for motorized movement support between the torso module and the respective thigh sections are located approximately in a region of hip joints of the person when the exoskeleton is attached to the person, wherein second connecting joints with respectively associated second drive motors for articulated connection and/or for motorized movement support between the respective thigh sections and the respectively associated lower leg sections are located approximately in a region of knee joints of the person when the exoskeleton is attached to the person and prepared for a walking mode, and wherein third connecting joints for the articulated connection between the respective lower leg portions and the respective associated foot sections are located approximately in region of ankle joints of the person when the exoskeleton is attached to the person, and
wherein motor-drivable wheels are associated with the lower leg portions and/or the knee joints or the second connecting joints, the motor-drivable wheels are inactive in the walking mode of the exoskeleton when the person is standing on a ground or moving by means of one or more of walking, stepping, climbing, or running movements and are in a position at a distance from the ground and/or from the foot section of the exoskeleton, and which are activated and/or motor-driven in a rolling mode of the exoskeleton and are in contact with the ground.

22. The exoskeleton according to claim 21, wherein third drive motors are assigned to the third connecting joints for motorized movement support of the articulated connection between the respective lower leg sections and the respective associated foot sections.

23. The exoskeleton according to claim 21, wherein the motor-drivable wheels are associated with the knee joints or the second connecting joints and/or are positioned in a vicinity of the knee joints of the person or in the vicinity of the second connecting joints.

24. The exoskeleton according to claim 23, wherein the second connecting joints, together with the motor-drivable wheels assigned thereto and/or positioned in a vicinity thereof, are assigned to the knee joints of the person in the walking mode of the exoskeleton when the person is standing on the ground or moving by means of walking and/or stepping and/or climbing and/or running movements and follow knee movements during the walking and/or stepping and/or climbing and/or running movements of the person and/or provide motor support for the knee movements via second drive motors.

25. The exoskeleton according to claim 23, wherein the second connecting joints, together with the motor-drivable wheels corresponding thereto and/or positioned in their vicinity, are distanced from the knee joints of the person in the rolling mode of the exoskeleton,
wherein wheels associated with the second connecting joints are in contact with the ground and are motor-driven, and
wherein the person connected to the exoskeleton is in a seated position.

26. The exoskeleton according to claim 25, wherein upper leg portions are oriented approximately vertically in the rolling mode of the exoskeleton, the lower leg portions hingewise connected thereto being oriented approximately horizontally.

27. The exoskeleton according to claim 25, wherein the lower leg portions are provided with non-driven support rollers which are in contact with the ground when the lower leg portions of the exoskeleton in the rolling mode are approximately horizontally aligned, the foot sections being at least slightly raised from the ground.

28. The exoskeleton according to claim 25, wherein the torso module is associated with an adjustable seat surface for the person in the seated position.

29. The exoskeleton according to claim 21, wherein the motor-drivable wheels are assigned to the lower leg sections and are arranged adjustably along their longitudinal direction.

30. The exoskeleton according to claim 29, wherein the motor-drivable wheels associated with the lower leg portions are inactive in the walking mode of the exoskeleton and are in a raised position between the respective foot section and the respective knee joint or second connecting joint at a distance from the ground and/or the foot section of the exoskeleton.

31. The exoskeleton according to claim 29, wherein the motor-drivable wheels are activated in the rolling mode of the exoskeleton and are in contact with the ground, wherein wheels in their respective lowered position lift the respective foot section off the ground.

32. The exoskeleton according to claim 31, wherein the motor-drivable wheels are coupled, at least in the rolling mode of the exoskeleton, to a control and/or regulating device which can provide balance control in a stabilized upright position of the exoskeleton and the person supported and/or assisted thereby.

33. The exoskeleton according to claim 31, wherein a permitted articulation angle of the second connecting joints is minimized in the rolling mode of the exoskeleton with the motor-drivable wheels activated and in rolling ground contact.

34. The exoskeleton according to claim 31, wherein a permitted articulation angle of the first connecting joints is minimized in the rolling mode of the exoskeleton with the motor-drivable wheels activated and in rolling ground contact.

35. A method for operating and handling the exoskeleton according to claim 21, comprising:
contacting the motor-drivable wheels with the ground; and
at least one of:
activating the motor-drivable wheels, or
driving a motor of the motor-drivable wheels.

36. The method according to claim 35, further comprising:
causing the second connecting joints of the exoskeleton to follow knee movements of the person during one or more of walking, climbing, or running movements of the person; and
providing motorized support for the knee movements via second drive motors.

37. The method according to claim 35, further comprising:
spacing the second connecting joints, together with the motor-drivable wheels associated with the second connecting joints, apart from the knee joints of the person in the rolling mode of the exoskeleton,
wherein wheels associated with the second connecting joints are in contact with the ground and are motor-driven, and
wherein the person connected to the exoskeleton is in a seated position.

38. The method according to claim 35, further comprising:
deactivating the motor-drivable wheels when in the walking mode of the exoskeleton and in a raised position distanced from the ground and/or from the foot section of the exoskeleton between the respective foot section and a knee joint or the respective second connecting joint.

39. The method according to claim 35, wherein contacting the motor-drivable wheels with the ground causes the motor-drivable wheels to lift the foot section off the ground.

40. The method according to claim 39, further comprising:
coupling the motor-drivable wheels to a control and/or regulating device to provide balance control in a stabilized upright position of the exoskeleton.
